(19) United States
(12) Patent Application Publication
(10) Pub. No.: US 2025/0160362 A1
(43) Pub. Date: May 22, 2025

(54) MEAT SUBSTITUTE PRODUCT

(71) Applicant: CARGILL, INCORPORATED, Wayzata, MN (US)

(72) Inventors: Karlee Christine BOX, Coon Rapids, MN (US); Diliara IASSONOVA, Maple Grove, MN (US); Alicia Esther Lam STUBE, Cottage Grove, MN (US)

(21) Appl. No.: 18/840,328

(22) PCT Filed: Feb. 20, 2023
(86) PCT No.: PCT/US2023/062900

§ 371 Date: Aug. 21, 2024

Related U.S. Application Data
(60) Provisional application No. 63/313,886, filed on Feb. 25, 2022.

(51) Int. Cl. A23J 3/22; A23D 9/007; A23J 3/14

(52) U.S. Cl. CPC A23J 3/227; A23D 9/007; A23J 3/14

(57) ABSTRACT

The present invention relates to a meat substitute product comprising a fat component, a wax, and at least one texturized protein ingredient. It relates further to a fat chip or fat bead comprising a a combination of solid fat and liquid oil and wax, and the wax is present in an amount of 1 to 10% by weight of the fat chip or fat bead. The invention further relates to the use of such a fat chip or fat bead for improving the appearance, texture and/or organoleptic properties of a ground meat substitute product. It further relates to a method of producing the meat substitute product. Preferably the meat substitute product is a vegetarian ground meat substitute product that is shaped into a form such as a burger, a patty, a meatball, a nugget or a sausage.

### CROSS-REFERENCE TO RELATED APPLICATIONS

This application claims the benefit of U.S. Provisional Application No. 63/313,886, filed Feb. 25, 2022, which is incorporated by reference herein in its entirety.

### FIELD OF THE INVENTION

The present invention relates to a meat substitute product comprising a fat composition, a wax and at least one texturized protein ingredient. The invention further relates to the use of a fat chip or fat bead for improving the appearance, texture and/or organoleptic properties of a meat substitute product. Preferably the meat substitute product is a vegetarian ground meat substitute product that is shaped into a form such as a burger, a patty, a meatball, a nugget or a sausage.

### BACKGROUND OF THE INVENTION

Traditionally, meat products have taken an important place in our western diet. Meat products are consumed in many different forms as whole muscle or minced pieces of meat that are cooked, grilled, smoked, cured or fermented in form of hamburgers, patties, sausages, meat balls, nuggets and many more.

There is a growing consumer trend for reducing or completely removing these animal products from their diet. Consumers switch towards plant-based meat substitutes because of various reasons such as health concerns, environmental concerns, sustainability or animal welfare.

In order for a regular meat consumer to be motivated to choose for meat substitutes, it is critical that these substitutes mimic the fibrous qualities provided by animal muscle fiber. The meat substitutes should resemble meat products in terms of appearance and texture during and after cooking. They should mimic organoleptic properties, like appearance, flavor, bite, succulence, and mouthfeel when being consumed.

Various functional ingredients in meat substitutes are required to mimic the taste, flavor, texture, mouthfeel and appearance of meat-based products.

Coconut oil is widely used in alternative meat products. However, coconut oil is high in saturated fatty acid content (88% to 91%), and is not matching sufficiently the functionality (melting and mouthfeel) to target fats such as tallow, lard and the like.

There is still a need to improve the appearance, texture and/or organoleptic properties of meat substitutes and more specifically of ground meat substitutes. The present invention provides such a solution.

### SUMMARY OF THE INVENTION

The present invention relates to a meat substitute product comprising a fat composition, a wax and at least one texturized protein ingredient. It relates further to a fat chip or fat bead comprising a combination of solid fat and liquid oil and the wax is present in an amount of 1 to 10% by weight of the fat chip or fat bead.

The invention further relates to the use of such a fat chip or fat bead for improving the appearance, texture and/or organoleptic properties of a ground meat substitute product.

It further relates to method of producing a meat substitute product according to the present invention and the method is comprising the following steps: mixing meat substitute product ingredients, adding wax, a fat composition consisting of a fat component and optionally additional liquid oil wherein the fat component is consisting of a solid fat and liquid oil, forming the meat substitute product. it further relates to a process for making a fat chip or fat bead.

### DETAILED DESCRIPTION

The present invention relates to a meat substitute product comprising a fat composition, a wax and at least one texturized protein ingredient.

Meat substitute products are food or feed compositions that mimic animal processed whole-muscle meat products as well as processed restructured meat products such as burgers, patties, sausages and the like. Methods of processing may be salting, chopping, fermentation, boiling, smoking, extrusion or other processes.

Meat substitute products can be divided into ground, also called minced, products and fine paste products. Ground meat substitute products are coarse-particle products such as alternatives for burgers, patties, sausages, meatballs, nuggets and the like. Fine paste products are typically emulsified products such as alternatives for frankfurter, bologna, mortadella and the like.

In one aspect of the invention, the meat substitute product is a ground meat substitute

The ground meat substitute product may be shaped in a form, such as the form of a burger, a patty, a meatball, a nugget or a sausage. In a preferred aspect of the invention, the meat substitute product is a ground and shaped meat substitute.

The meat substitute product is a vegetarian protein product, preferably a ground vegetarian protein product and it is not based on meat or fish. More preferably the ground meat substitute product is a ground vegan protein product. The ground vegan protein product is not based on products derived from animals. Examples of products derived from animals are amongst others meat, fish, eggs, milk or honey.

The meat substitute product of the present invention is typically designed for consumption after cooking.

Alternatively, the meat substitute product of the present invention is a pet food. The term “pet food” means any food composition intended to be consumed by a pet. A pet may be any domestic or tamed animal kept for companionship or pleasure. For example, the pet can be an avian, bovine, canine, equine, feline, hircine, lupine, murine, ovine, or porcine animal. Preferably, the pet is a dog or a cat.

The meat substitute product of the present invention is comprising the fat composition in an amount of from 2 to 25% by weight of said meat substitute product. It further relates to a meat substitute product wherein the fat composition is present in an amount of from 4 to 15%, or from 5 to 12%, by weight of said meat substitute product.

The fat composition is present in the meat substitute product as a combination of a fat component, and optionally additional liquid oil, wherein the fat component itself is a combination of solid fat and liquid oil. The liquid oil of the fat component can be the same or different from the optional additional liquid oil of the fat composition.

The term “oil or fat” relates to a lipophilic substance that is substantially containing triglycerides, i.e. at least 90 wt. %, at least 95 wt. %, or at least 97 wt. % of triglycerides, expressed on total weight of the oil/fat. The oil may further comprise mono- and diglycerides, as well as free fatty acids in a combined amount of less than 10 wt. %, less than 5 wt. %, or less than 3 wt. %, expressed on total weight of the oil/fat.

Liquid oil is an oil that is liquid at room temperature (20° C.), thus having a melting point of less than 20° C. The liquid oil can be one liquid oil or a blend of more than one liquid oils. In case of a blend of liquid oils, it is understood that the blend of the more than one liquid oil has a melting point of less than 20° C.

The “liquid oil” is a vegetable oil.

Examples of vegetable liquid oils are amongst others double fractionated palm olein, cottonseed oil, corn oil, groundnut oil, linseed oil, olive oil, rapeseed oil, rice bran oil, sesame oil, safflower oil, soy bean oil, sunflower oil, oil from any variety of oilseeds with increased level of unsaturated fatty acids compared to the original seed variety, such as mid or high oleic sunflower oil. These varieties with increased levels of unsaturated fatty acids can be obtained by natural selection or by genetic modification (GMO). Preferably, the vegetable oil is selected from the group consisting of cottonseed oil, corn oil, grapeseed oil, groundnut oil, linseed oil, olive oil, peanut oil, rapeseed oil, rice bran oil, sesame oil, safflower oil, soy bean oil, sunflower oil, their corresponding high oleic varieties, and mixture of two or more thereof. The high oleic varieties are containing at least 40%, at least 50%, at least 60%, at least 70% and preferably at least 80% oleic acid in respect of the fatty acid profile. The liquid oil is selected from the group consisting of rapeseed oil, high oleic rapeseed oil, sunflower oil, high oleic sunflower oil, canola oil, high oleic canola oil, high oleic soy bean oil, soybean oil, flaxseed oil, grapeseed oil, olive oil, peanut oil, corn oil, groundnut oil, cottonseed oil and a combination of two or more thereof.

Preferably, the vegetable oil is selected from the group consisting of corn oil, rapeseed oil, canola oil, cottonseed oil, soy bean oil, sunflower oil, their corresponding high oleic varieties, and mixture of two or more thereof.

In an aspect of the invention, the liquid oil is selected from the group consisting of canola oil, high oleic rapeseed oil, high oleic canola oil, soybean oil, cottonseed oil and a combination of two or more thereof.

The term “solid fat” refers to a fat that is solid at room temperature (20° C.)

The solid fat is selected from the group consisting of palm oil, palm kernel oil, coconut oil, cacao butter, shea butter and a combination of two or more thereof.

In a more specific aspect of the invention, the fat component comprises coconut oil and a liquid oil selected from the group consisting of high oleic rapeseed oil, high oleic canola oil, soy bean oil, cottonseed oil and a combination of two or more thereof.

The fat component of the fat composition is comprising the solid fat in an amount of from 50 to 90%, from 60 to 80%, from 65 to 75% by weight of the fat component

The fat component is further comprising the liquid oil in an amount of from 10 to 50%, from 25 to 35% by weight of the fat component.

The fat component is further comprising the liquid oil in an amount of from 20 to 40%, from 27 to 30% by weight of the fat component

The optionally additional liquid oil of the fat composition is present in an amount of 0 to 50 wt %, or 10 to 40 wt. %, or 20 to 30 wt % based upon the weight of the fat composition.

The meat substitute product of the present invention further comprises wax. Wax is a known component that is obtained from vegetable oils. Waxes are organic compounds that characteristically consist of long aliphatic alkyl chains, although aromatic compounds may also be present. Waxes may contain unsaturated bonds and include various functional groups such as fatty acids, primary and secondary alcohols, ketones, aldehydes, and fatty acid esters. The wax is selected from rice bran wax, sunflower wax, candelilla and carnauba wax. Preferably, the wax is selected from rice bran wax, sunflower wax or a combination of the two. Rice bran wax is the vegetable wax extracted from the bran oil of rice. It has a melting point of about 77 to 86° C. Sunflower wax is a vegetable wax obtained from the winterization of sunflower oil. This wax consists of long chain, saturated C-42 to C-60 esters. These esters correlate to hardness, crystalline structure, and a melting point between 75 to 80° C. Candelilla wax is a wax derived from the leaves of the small Candelilla shrub from the family Euphorbiaceae. It has a melting point of about 68 to 73° C. Carnauba wax is a wax of the leaves of the carnauba palm Copernicia prunifera. It has a melting point of about 82° C.

Without wishing to be bound by any theory, it may be expected that wax is present as a structuring agent and/or shows oil-binding properties and thus immobilizes the liquid oil in the structure.

In an aspect of the invention, the wax is present in an amount of from 1 to 10%, from 2 to 8%, 3 to 5% by weight of the fat composition.

In a further aspect of the invention, the fat component of the fat composition and the wax are mixed to prepare a powder or a fat chip or fat bead. Fat chips or fat beads are easy to handle, disperse readily and melt appropriately quickly.

Fat chip is rather an irregular formed piece of fat. The fat chipcan be prepared by melting the fat component and the wax, then pour it into molds and freeze it, in for example a blast freezer. Further size reduction can be done in the food processor to achieve the final chip size.

Fat bead is rather more like a round shaped piece of fat. Fat beads can be prepared by pouring the fats (=solid fat and liquid oil) of the fat component and the wax at a temperature of between about 24 to 50°° C. at a flow of about 20L/min in cryogran unit (e.g. IQF inc. Cryogenic granulator model 250S). The frozen product in bead form is collected at the end of the line.

Such a powder, preferably a fat chip or fat bead is comprising a fat component and wax as a structuring agent wherein the fat component is a combination of solid fat and liquid oil and the wax is present in an amount of 1 to 10%, 2 to 8%, 5 to 7% by weight of the fat chip or fat bead. Specifically, such a fat chip or fat bead is comprising solid fat/liquid oil/wax in a ratio of 32/60/8, 40/55/5, 60/35/5 to 75/20/5

In a preferred aspect of the invention the solid fat is coconut oil and the liquid oil selected from the group consisting of high oleic rapeseed oil, high oleic canola oil, soybean oil, cottonseed oil and a combination of two or more thereof. The wax is selected from rice bran wax, sunflower wax, candelilla and carnauba wax and the solid fat/liquid oil/wax ratios is from 32/60/8, 40/55/5, 60/35/5 to 75/20/5.

In one aspect of the invention, the meat substitute product is comprising a fat component and wax, wherein the fat component is consisting of a solid fat and a liquid oil.

In another aspect of the invention, the meat substitute product is comprising wax and a fat composition consisting of a fat component, and additional liquid oil, wherein the fat component is consisting of a solid fat and a liquid fat.

In another aspect of the invention, the meat substitute product is comprising an additional liquid oil and a fat chip consisting of a solid fat, a liquid fat and wax.

The meat substitute product also comprises at least a texturized protein ingredient. A texturized protein is a fibrous protein product. It may enhance the textural and sensorial quality of the meat substitute product. It may influence the bite, succulence and/or moistness of the meat substitute product. Textured (texturized) protein provides, inter alia, meat-like texture (e.g., bite and chewiness) and water holding properties to a meat substitute product.

Preferably the at least one texturized protein ingredient is from a vegetable source, i.e. a texturized vegetable protein. A texturized vegetable protein is a processed vegetable product usually made from high protein flour or its protein concentrate through an extrusion process, such as dry extrusion, at high temperature and pressure to produce a fibrous, insoluble and porous product. Dry extrusion can be carried out for instance in a twin-screw extruder. Typically, in a dry extrusion process, the moisture content of the composition being extruded is at most 30wt %, for instance from 8 to 30 wt %, or from 10 to 30 wt %, or from 15 to 25 wt %, or from 15 to 22 wt % based on the total weight of the protein. Processing aids may be used in the extrusion process, for instance, known pH buffering systems like caustic, vinegar or other edible acids.

The at least one texturized vegetable protein is sourced amongst others from pea protein, chickpea beans protein, soy protein, cotton seed protein, sunflower seed protein, lupin protein, oat protein, lentil protein, sesame seed protein, canola protein, broad been protein, horse bean protein, alfalfa protein, clover protein, rice protein, tapioca protein, potato protein, carob protein, wheat protein, corn protein and a combination of two or more thereof. Preferably the at least one protein ingredient is sourced from the group selected from soy, pea, corn, cottonseed, wheat, sunflower seed, oats or combinations of two or more thereof. More preferably, the at least one texturized protein ingredient is sourced from soy, pea, wheat, sunflower, or mixtures of two or more thereof. More preferably, the at least one texturized protein ingredient is texturized soy protein and/or texturized pea protein.

In one aspect of the invention, the at least one texturized protein ingredient is present in the meat substitute product in an amount of from 7 to 25%, from 12 to 22%, or from 15 to 20%, expressed as weight on total weight of the meat substitute product.

In one more aspect of the invention, the meat substitute product also comprises a further protein ingredient which is not texturized. This protein ingredient may be present in the meat substitute product for providing good emulsification, protein enrichment, elasticity, gelation and/or water binding effect. This protein ingredient may be from plants, fungi, algae, insects, animals or a mixture of two or more thereof. Examples of animal protein ingredients are egg protein, dairy products such as whey or casein, or combinations of two or more thereof. Examples of plant proteins are amongst others soy, wheat, legume proteins, e.g. pea or chickpea, lupine, rice, canola, or mixtures of two or more thereof. Preferably the protein ingredient is sourced from plants, fungi, algae, or a mixture of two or more thereof. Preferably the protein is sourced from pea.

In yet another aspect of the invention, the protein ingredient that is not texturized is present in an amount of from 1.0 to 10.0 wt %, from 2.0 to 8.0 wt %, or from 3.0 to 5.0 wt % on the total weight of meat substitute product.

In one further aspect of the invention, the meat substitute product is further comprising one or more hydrocolloids. Hydrocolloids are polysaccharides of high molecular weight, extracted from plants, seaweeds or produced by microbial synthesis. Hydrocolloids are substances that form colloidal systems when dispersed in water. Examples of hydrocolloids are starches, xanthan gum, guar gum, locust bean gum, konjac gum, cellulose derivatives, alginate, pectin, carrageenan, gellan gum, agar, plant fibers or combinations of two or more thereof. Starches may be from various botanical sources that include, but are not limited to, potato starch, tapioca starch, rice starch, pea starch, waxy corn starch, wheat starch, or maize starch. They may be in form of native starch, physically or chemically modified starch, or combinations of two or more thereof. Cellulose derivatives may be methyl cellulose, carboxymethyl cellulose and/or hydroxypropyl methylcellulose.

Examples of plant-based fiber that can be present include, but are not limited to, citrus fibers, legume fibers (e.g., pea fibers), flax fibers, potato fibers, psyllium fibers, bamboo fibers, apple fibers, carrot fibers, tapioca fibers, plantain fibers, cane sugar fibers, cereal fibers (e.g., millet fibers, oat fibers, barley fibers, corn fibers, wheat fibers), or combinations of two or more thereof.

The amount of each hydrocolloid, if present, is preferably in an amount of from 0.1 to 3.0 wt %, from 0.2 to 2.5 wt %, or from 0.3 to 2.0 wt % on the total weight of the meat substitute product.

Preferably, the one or more hydrocolloids are selected from the group consisting of starch, cellulose derivates, carrageenan, xanthan gum or fiber. Preferably, carrageenan and methylcellulose are used.

The one or more hydrocolloids may be added to the meat substitute product for their binding capacity and their ability for gelling during cooking of the meat substitute product. This may influence the moistness and succulence of the meat alternative product and may also influence the firmness of bite.

In another aspect of the invention, the meat substitute product comprises salt. The amount of salt is present in a range of from 0.1 to 3.0 wt %, from 0.2 to 2.5 wt %, from 0.5 to 2.0 wt %, or from 0.8 to 1.5 wt % on the total weight of meat substitute product. Salt can be any standard food-grade kitchen salt (e.g., sodium chloride).

In yet one more aspect of the invention, the meat substitute product comprises one or more ingredients selected from sodium ascorbates, citrates, sodium carbonates, sweeteners, flavoring agents, flavor enhancers, spices/seasonings and preservatives. The amount of each of these ingredients, if present, is preferably in a range of from 0.01 to 10.0 wt %, from 0.02 to 5.0 wt %, from 0.05 to 3% on the total weight of the meat substitute product.

In another aspect of the invention, the recipe of the meat substitute product further comprises water. The total amount of water is in an amount of from 30 to 80 wt %, from 35 to 75 wt %, or from 40 to 70 wt % on the total weight of meat substitute product. The total amount of water refers to the added amount of water that is used to disperse ingredients of the meat substitute composition (additional water). as well as the amount of water that is used to hydrate the texturized protein ingredient and disperse flavoring agents and coloring agents (hydration water). Hydration of the texturized protein ingredient may typically be done in a ratio of 1 part of dry texturized protein ingredient on 2 up to 3 or 5 parts of water. Typically, the added water can be used for hydrating, dispersing or binding and texturizing ingredients.

In one aspect of the invention, the meat substitute product is comprising:
a fat composition and wax, and
at least one texturized protein ingredient, and
a protein ingredient, and
one or more hydrocolloids, and
wherein the fat composition is consisting of a fat component and optionally liquid oil and the fat component is a combination of a solid fat and a liquid oil.
and
wherein the meat substitute product is a ground meat substitute product, preferably a ground vegetarian protein product.

In one preferred aspect of the invention, the meat substitute product is comprising:
a fat composition in an amount of from 2 to 25% by weight of said meat substitute product on the total weight of the meat substitute product, and wax present in an amount of from 1 to 10%, from 2 to 8%, 3 to 5% by weight of the fat composition, and
at least one texturized protein ingredient in an amount of from 10 to 25%, from 12 to 22%, or from 15 to 20%, expressed as dry weight on total weight of the meat substitute product, and
a protein ingredient an amount of from 1.0 to 10.0 wt %, from 2.0 to 8.0 wt %, or from 3.0 to 5.0 wt % on the total weight of meat substitute product, and
one or more hydrocolloids in an amount for each hydrocolloid, of from 0.1 to 3.0 wt %, from 0.2 to 2.5 wt %, or from 0.3 to 2.0 wt % on the total weight of the meat substitute product, and
wherein the meat substitute product is a ground meat substitute product, preferably a ground vegetarian protein product.

In one more preferred aspect of the invention, the meat substitute product is comprising:
a fat composition in an amount of from 2 to 25% on the total weight of the meat substitute product, and wax present in an amount of from 1 to 10%, from 2 to 8%, 3 to 5% by weight of the fat component, and
at least one texturized protein ingredient in an amount of from 10 to 25%, from 12 to 22%, or from 15 to 20%, expressed as dry weight on total weight of the meat substitute product, and
a protein ingredient an amount of from 1.0 to 10.0 wt %, from 2.0 to 8.0 wt %, or from 3.0 to 5.0 wt % on the total weight of meat substitute product, and
one or more hydrocolloids in an amount for each hydrocolloid, of from 0.1 to 3.0 wt %, from 0.2 to 2.5 wt %, or from 0.3 to 2.0 wt % on the total weight of the meat substitute product, and
wherein the fat composition is consisting of a fat component and optionally liquid oil and wherein the fat component, consisting of a solid fat and liquid oil, and the wax is formed into fat chip or fat bead thus consisting of solid fat/liquid oil/wax; and the solid fat is coconut oil and the liquid oil is selected from the group consisting of rapeseed oil, canola oil, high oleic rapeseed oil, high oleic canola oil, soybean oil, cottonseed oil and a combination of two or more thereof; and the wax is selected from rice bran wax, sunflower wax, candelilla and carnauba wax; and the solid fat/liquid oil/wax ratios in the fat chip is from 32/60/8, 40/55/5, 60/35/5 to 75/20/5 and
wherein the meat substitute product is a ground meat substitute product, preferably a ground vegetarian protein product.

The meat substitute product according of the present invention that is comprising the fat composition and the wax, has a uniform texture and good level of juiciness. The meat substitute product has a good integrity during baking, frying and/or handling of the product.

The meat substitute product of the present invention has a content of saturated fatty acids that is reduced with at least 20%, at least 30%, at least 40%, at least 50% in comparison with meat substitute product wherein coconut oil as the sole fat component is used.

The meat substitute product may be prepared in a process where the at least one texturized protein ingredient is hydrated and subsequently mixed with the rest of the dry ingredients and water in order to obtain a doughy product, i.e. the meat substitute dough. All steps for the preparation of the meat substitute dough are executed at a temperature below 8° C., even below 5° C.

The meat substitute dough is subsequently shaped into a form, such as a burger, a patty, a meatball, a nugget, a sausage or the like. The shaped forms can be stored at 4° C., can be frozen at −18° C. or can be heat treated (like steam cooking, pan frying or oven baking) prior to storing at 4° C. or freezing at −18° C.

The invention relates to the use of a fat chip or fat bead, comprising a combination of solid fat and liquid oil and the wax is present in an amount of 1 to 10%, 2 to 8%, 3 to 5% by weight of the fat chip or fat bead, for improving the appearance, texture and/or organoleptic properties of a ground meat substitute product.

The current invention relates to the use, wherein the fat chip or fat bead is comprising a combination of solid fat and liquid oil and the wax is present in an amount of 1 to 10%, 2 to 8%, 3 to 5% by weight of the fat chip or fat bead. Specifically, such a fat chip or fat bead is comprising solid fat/liquid oil/wax in a ratio of from 32/60/8, 40/55/5, 60/35/5 to 75/20/5.

In a further aspect of the invention it relates to the use of the fat chip or fat bead wherein the solid fat is coconut oil and the liquid oil selected from the group consisting of high oleic rapeseed oil, high oleic canola oil, soy bean oil, cottonseed oil and a combination of two or more thereof, the wax is selected from rice bran wax, sunflower wax, candelilla and carnauba wax and the solid fat/liquid oil/wax ratios is from 32/60/8, 40/55/5, 60/35/5 to 75/20/5.

The current invention further relates to the use of fat chip or fat bead comprising a combination of solid fat and liquid oil and the wax is present in an amount of 1 to 10%, 2 to 8%, 3 to 5% by weight of the fat chip or fat bead, for reducing the content of saturated fatty acids with at least 20%, at least 30%.

Amongst others, it has been noted that fat chips or fat beads with high Mettler Dropping Point (MDP) are good for processing at 10-12° C. to provide the most “natural” animal fat appearance in finished raw products.

The liquid oil that is added beyond the fat chips or fat beads is used for the methylcellulose emulsion and the fat chips or fat beads provide for the tallow-like visual and well as for the juiciness and flavor.

### Clauses

1. A meat substitute product comprising a fat composition, a wax, and at least one texturized protein ingredient.

2. The meat substitute product according to clause 1 wherein the wax is selected from rice bran wax, sunflower wax, candelilla and carnauba wax.

3. The meat substitute product according to any one of the preceding clauses, wherein the meat substitute product comprises the fat composition in an amount of 2 to 25% by weight of said meat substitute product.

4. The meat substitute product according to any one of the preceding clauses wherein the fat composition is present in an amount of from 4 to 15%, by weight of said meat substitute product.

5. The meat substitute product according to any one of the preceding clauses wherein the fat composition is present in an amount of from 5 to 12%, by weight of said meat substitute product.

6. The meat substitute product according to any one of the preceding clauses, wherein the fat composition present in the meat substitute product is consisting of a fat component and optionally additional liquid oil, and the fat component is consisting fo a solid fat and liquid oil.

7. The meat substitute product according to clause 6, wherein the solid fat is selected from the group consisting of palm oil, palm kernel oil, coconut oil, cacao butter, shea butter and a combination of two or more thereof.

8. The meat substitute product according to clause 6, wherein the solid fat is coconut oil.

9 The meat substitute product according to anyone of clauses 6 to 8, wherein the liquid oil is selected from the group consisting of: rapeseed oil, high oleic rapeseed oil, sunflower oil, high oleic sunflower oil, canola oil, high oleic canola oil, high oleic soybean oil, soybean oil, flaxseed oil, grapeseed oil, olive oil, peanut oil, corn oil, groundnut oil, cottonseed oil and a combination of two or more thereof.

10. The meat substitute product according to anyone of clauses 6 to 8, wherein the liquid oil is selected from the group consisting of rapeseed oil, canola oil, high oleic rapeseed oil, high oleic canola oil, soybean oil, cottonseed oil and a combination of two or more thereof.

11. The meat substitute product according to anyone of preceding clauses, wherein the fat composition is present in an amount of 2 to 25% by weight of said meat substitute product, and wherein the fat composition is consisting of a fat component and optionally additional liquid oil and the fat component is consisting of coconut oil and a liquid oil selected from the group consisting of, high oleic rapeseed oil, high oleic canola oil, soybean oil, and cottonseed oil and a combination of two or more thereof.

12. The meat substitute product according to anyone of preceding clauses, wherein the fat composition is present in an amount of 4 to 15% by weight of said meat substitute product, and wherein the fat composition is consisting of a fat component and optionally additional liquid oil and the fat component is consisting of coconut oil and a liquid oil selected from the group consisting of rapeseed oil, canola oil, high oleic rapeseed oil, high oleic canola oil, soy bean oil, and cottonseed oil and a combination of two or more thereof.

13. The meat substitute product according to anyone of preceding clauses, wherein the fat composition is present in an amount of 5 to 12% by weight of said meat substitute product, and wherein the fat composition is consisting of a fat component and optionally additional liquid oil and the fat component is consisting of coconut oil and a liquid oil selected from the group consisting of rapeseed oil, canola oil, high oleic rapeseed oil, high oleic canola oil, soy bean oil, and cottonseed oil and a combination of two or more thereof.

14. The meat substitute product according to anyone of preceding clauses, wherein the fat composition is present in an amount of 2 to 25% by weight of said meat substitute product, and wherein the fat composition is consisting of a fat component and additional liquid oil and the fat component is consisting of coconut oil and a liquid oil selected from the group consisting of rapeseed oil, canola oil, high oleic rapeseed oil, high oleic canola oil, soy bean oil, and cottonseed oil and a combination of two or more thereof, and wherein the additional liquid is the same or different from the liquid oil in the fat component.

15. The meat substitute product according to anyone of preceding clauses, wherein the fat composition is present in an amount of 4 to 15% by weight of said meat substitute product, and wherein the fat composition is consisting of a fat component and additional liquid oil and the fat component is consisting of coconut oil and a liquid oil selected from the group consisting of rapeseed oil, canola oil, high oleic rapeseed oil, high oleic canola oil, soy bean oil, and cottonseed oil and a combination of two or more thereof, and wherein the additional liquid is the same or different from the liquid oil in the fat component.

16. The meat substitute product according to anyone of preceding clauses, wherein the fat composition is present in an amount of 5 to 12% by weight of said meat substitute product, and wherein the fat composition is consisting of a fat component and additional liquid oil and the fat component is consisting of coconut oil and a liquid oil selected from the group consisting of rapeseed oil, canola oil, high oleic rapeseed oil, high oleic canola oil, soy bean oil, and cottonseed oil and a combination of two or more thereof and wherein the additional liquid is the same or different from the liquid oil in the fat component.

17. The meat substitute product according to any one of the preceding clauses, wherein the meat substitute product comprises the wax in an amount of 1 to 10% by weight of the fat composition.

18. The meat substitute product according to any one of the preceding clauses, wherein the meat substitute product comprises the wax in an amount of 2 to 8% by weight of the fat composition.

19. The meat substitute product according to any one of the preceding clauses, wherein the meat substitute product comprises the wax in an amount of 3 to 5% by weight of the fat composition.

20. The meat substitute product according to any one of the preceding clauses, wherein the texturized protein ingredient is from a vegetable source selected from the group consisting of pea protein, chickpea beans protein, soy protein, cotton seed protein, sunflower seed protein, lupin protein, oat protein, lentil protein, sesame seed protein, canola protein, broad been protein, horse bean protein, alfalfa protein, clover protein, rice protein, tapioca protein, potato protein, carob protein, wheat protein, com protein and a combination of two or more thereof.

21. The meat substitute product according to any one of the preceding clauses, wherein the texturized protein ingredient is from a vegetable source selected from the group consisting of pea protein, chickpea beans protein, soy protein, wheat protein, sunflower protein, and a combination of two or more thereof.

22. The meat substitute product according to any one of the preceding clauses, wherein the texturized protein ingredient is from a vegetable source selected from pea protein, soy protein, or a combination of the two.

23. The meat substitute product according to any one of the preceding clauses wherein the texturized protein is an extruded protein.

24. The meat substitute product according to any one of the preceding clauses comprising the fat composition in an amount of 2-25% by weight of the meat substitute product, wax in an amount of 0.02-0.7% by weight of the meat substitute product, texturized protein ingredient in an amount of 7-25% by weight of the meat substitute product.

25. The meat substitute product according to any one of the preceding clauses comprising the fat composition in an amount of 2-25% by weight of the meat substitute product, wax in an amount of 0.02-0.7% by weight of the meat substitute product, texturized protein ingredient in an amount of 12-22% by weight of the meat substitute product.

26. The meat substitute product according to any one of the preceding clauses comprising the fat composition in an amount of 2-25% by weight of the meat substitute product, wax in an amount of 0.05-0.5% by weight of the meat substitute product, texturized protein ingredient in an amount of 15-20% by weight of the meat substitute product.

27. The meat substitute product according to any one of the preceding clauses comprising the fat composition in an amount of 2-25% by weight of the meat substitute product, wax in an amount of 0.02-0.7% by weight of the meat substitute product, texturized protein ingredient in an amount of 15-20% by weight of the meat substitute product.

28. The meat substitute product according to any one of the preceding clauses comprising the fat composition in an amount of 2-25% by weight of the meat substitute product, wax in an amount of 0.05-0.5% by weight of the meat substitute product, texturized protein ingredient in an amount of 7-25% by weight of the meat substitute product.

29. The meat substitute product according to any one of the preceding clauses comprising the fat composition in an amount of 2-25% by weight of the meat substitute product, wax in an amount of 0.05-0.5% % by weight of the meat substitute product, texturized protein ingredient in an amount of 12-22% by weight of the meat substitute product

30. The meat substitute product according to any one of the preceding clauses comprising the fat composition in an amount of 5-12% by weight of the meat substitute product, wax in an amount of 0.02-0.7% by weight of the meat substitute product, texturized protein ingredient in an amount of 15-20% by weight of the meat substitute product.

31. The meat substitute product according to any one of the preceding clauses comprising the fat composition in an amount of 5-12% by weight of the meat substitute product, wax in an amount of 0.05-0.5% by weight of the meat substitute product, texturized protein ingredient in an amount of 15-20% by weight of the meat substitute product.

32. The meat substitute product according to any one of the preceding clauses comprising the fat composition in an amount of 5-12% by weight of the meat substitute product, wax in an amount of 0.02-0.7% by weight of the meat substitute product, texturized protein ingredient in an amount of 7-25% by weight of the meat substitute product.

33. The meat substitute product according to any one of the preceding clauses comprising the fat composition in an amount of 4-15% by weight of the meat substitute product, wax in an amount of 0.05-0.5% by weight of the meat substitute product, texturized protein ingredient in an amount of 15-20% by weight of the meat substitute product.

34. The meat substitute product according to any one of the preceding clauses comprising the fat composition in an amount of 5-12% by weight of the meat substitute product, wax in an amount of 0.05-0.5% by weight of the meat substitute product, texturized protein ingredient in an amount of 7-25% by weight of the meat substitute product.

35. The meat substitute product according to any one of the preceding clauses comprising the fat composition in an amount of 4-15% by weight of the meat substitute product, wax in an amount of 0.05-0.5% by weight of the meat substitute product, texturized protein ingredient in an amount of 7-25% by weight of the meat substitute product.

36. The meat substitute product according to any one of the preceding clauses comprising the fat composition in an amount of 4-15% by weight of the meat substitute product, wax in an amount of 0.02-0.7% by weight of the meat substitute product, texturized protein ingredient in an amount of 7-25% by weight of the meat substitute product.

37. The meat substitute product according to any one of the preceding clauses comprising the fat composition in an amount of 4-15% by weight of the meat substitute product, wax in an amount of 0.05-0.5% by weight of the meat substitute product, texturized protein ingredient in an amount of 12-22% by weight of the meat substitute product.

38. The meat substitute product according to any one of the preceding clauses comprising the fat composition in an amount of 4-15% by weight of the meat substitute product, wax in an amount of 0.02-0.7% by weight of the meat substitute product, texturized protein ingredient in an amount of 15-20% by weight of the meat substitute product.

39. The meat substitute product according to any one of the preceding clauses comprising the fat composition in an amount of 5-12% by weight of the meat substitute product, wax in an amount of 0.05-0.5% by weight of the meat substitute product, texturized protein ingredient in an amount of 12-22% by weight of the meat substitute product.

40. The meat substitute product according to any one of the preceding clauses comprising the fat composition in an amount of 5-12% by weight of the meat substitute product, wax in an amount of 0.02-0.7% by weight of the meat substitute product, texturized protein ingredient in an amount of 15-20% by weight of the meat substitute product.

41. The meat substitute product according to any one of the preceding clauses further comprising one or more hydrocolloids in an amount for each hydrocolloid, of from 0.1 to 3.0 wt %, on the total weight of the meat substitute product, and wherein the meat substitute product is a ground meat substitute product, preferably a ground vegetarian protein product.

42. The meat substitute product according to any one of the preceding clauses further comprising and one or more hydrocolloids in an amount for each hydrocolloid, of from 0.2 to 2.5 wt %, on the total weight of the meat substitute product, and wherein the meat substitute product is a ground meat substitute product, preferably a ground vegetarian protein product.

43. The meat substitute product according to any one of the preceding clauses further comprising one or more hydrocolloids in an amount for each hydrocolloid, of from 0.3 to 2.0 wt % on the total weight of the meat substitute product, and wherein the meat substitute product is a ground meat substitute product, preferably a ground vegetarian protein product.

44. A fat chip or fat bead comprising a fat component and wax as a structuring agent wherein fat component is a combination of solid fat and liquid oil and the wax is present in an amount of 1 to 10% by weight of the fat chip or fat bead.

45. A fat chip or fat bead according to clause 44 comprising a fat component and wax as a structuring agent wherein fat component is a combination of solid fat and liquid oil and the wax is present in an amount of 1 to 8% by weight of the fat chip or fat bead.

46. The fat chip or fat bead according to clause 44 to 45 comprising solid fat/liquid oil/wax in a ratio of 32/60/8.

47. The fat chip or fat bead according to any one of clauses 44 to 46 comprising solid fat/liquid oil/wax in a ratio of 40/55/5.

48. The fat chip or fat bead according to any one of clauses 44 to 47 comprising solid fat/liquid oil/wax in a ratio of 60/35/5.

49. The fat chip or fat bead according to any one of clauses 44 to 48 comprising solid fat/liquid oil/wax in a ratio of 65/30/5.

50. The fat chip or fat bead according to any one of clauses 44 to 49 comprising solid fat/liquid oil/wax in a ratio of 75/20/5.

51. The fat chip or fat bead according to any one of clauses 44 to 50 wherein the solid fat is selected from the group consisting of palm oil, palm kernel oil, coconut oil, cacao butter, shea butter and a combination of two or more thereof.

52. The fat chip or fat bead according to any one of clauses 44 to 51, wherein the solid fat is coconut oil.

53. The fat chip or fat bead according to anyone of clauses 44 to 52, wherein the liquid oil is selected from the group consisting of: rapeseed oil, high oleic rapeseed oil, sunflower oil, high oleic sunflower oil, canola oil, high oleic canola oil, high oleic soybean oil, soybean oil, flaxseed oil, grapeseed oil, olive oil, peanut oil, corn oil, groundnut oil, cottonseed oil and a combination of two or more thereof.

54. The fat chip or fat bead according to anyone of clauses 44 to 53, wherein the liquid oil is selected from the group consisting of: rapeseed oil, canola oil, high oleic rapeseed oil, high oleic canola oil, soybean oil, cottonseed oil and a combination of two or more thereof.

55. The fat chip or fat bead according to anyone of clauses 44 to 54, wherein the wax is selected from rice bran wax, sunflower wax, candelilla and carnauba wax.

56. The fat chip or fat bead according to anyone of clauses 44 to 55 wherein the wax is present in an amount of 1 to 8% based upon the weight of the fat chip or fat bead.

57. The fat chip or fat bead according to anyone of clauses 44 to 56 wherein the wax is present in an amount of 1 to 7% based upon the weight of the fat chip or fat bead.

58. The fat chip or fat bead according to anyone of clauses 44 to 57 wherein the wax is present in an amount of 1 to 5% based upon the weight of the fat chip or fat bead.

59. A process for preparing a fat chip or fat bead according to anyone of clauses 44 to 57 and comprising the following steps; melting the fat component of the fat chip or fat bead; melting the wax; pouring the molten mass into molds followed by freezing.

60. A process for preparing a fat chip or fat bead according to anyone of clauses 44 to 57 and comprising the following steps; pouring the fat component and the wax of the fat bead or fat chip at a temperature of 20 to 50° C. and at a flow of 10 to 30 l/min in a cryogran unit; collecting the frozen fat beads or fat chips.

61. The meat substitute product according to anyone of clauses 1 to 43 comprising the fat chip or fat bead according to anyone of clauses 44 to 58 and optionally additional liquid oil.

62. The meat substitute product according to anyone of clauses 1 to 43 or clause 61 wherein the fat chip or fat chip according to anyone of clauses 44 to 58 is present in an amount of 2 to 25% and the additional liquid oil is present in an amount of 0% to 10%.

63. The meat substitute product according to anyone of clauses 1 to 43 or any one of clauses 61 to 62 wherein the fat chip or fat chip according to anyone of clauses 44 to 58 is present in an amount of 2 to 25% and the additional liquid oil is present in an amount of 0% to 5%.

64. The meat substitute product according to anyone of clauses 1 to 44 or any one of clauses 61 to 63 wherein the fat chip or fat chip according to anyone of clauses 44 to 58 is present in an amount of 5 to 20% and the additional liquid oil is present in an amount of 1% to 5%.

65. The meat substitute product according to anyone of clauses 1 to 44 or any one of clauses 61 to 64 wherein the fat chip or fat chip according to anyone of clauses 44 to 58 is present in an amount of 2 to 10% and the additional liquid oil is present in an amount of 0% to 5%.

66. The meat substitute product according to anyone of clauses 1 to 44 or any one of clauses 61 to 65 wherein the fat chip or fat chip according to anyone of clauses 44 to 58 is present in an amount of 2 to 10% and the additional liquid oil is present in an amount of 1% to 5%.

67. The meat substitute product according to anyone of clauses 1 to 43 or any one of clauses 61 to 66 comprising:
a fat composition in an amount of from 2 to 25% on the total weight of the meat substitute product, and wax present in an amount of from 1 to 10 by weight of the fat composition and
at least one texturized protein ingredient in an amount of from 10 to 25%, expressed as dry weight on total weight of the meat substitute product, and
a protein ingredient an amount of from 1.0 to 10.0 wt %, on the total weight of meat substitute product, and
one or more hydrocolloids in an amount of each hydrocolloid, in an amount of from 0.1 to 3.0 wt %, on the total weight of the meat substitute product, and
wherein the fat composition is present as a fat component and optionally additional liquid oil and the fat component is further structured with the wax into a fat chip or fat bead; and the fat chip or fat bead is consisting of solid fat/liquid oil/wax; and the solid fat is coconut oil and the liquid oil is selected from the group consisting of rapeseed oil, canola oil, high oleic rapeseed oil, high oleic canola oil, soybean oil, cottonseed oil and a combination of two or more thereof; and the wax is selected from rice bran wax, sunflower wax, candelilla and carnauba wax; and the solid fat/liquid oil/wax ratios in the fat chip is from 32/60/8 to 75/20/5, and
wherein the meat substitute product is a ground meat substitute product, preferably a ground vegetarian protein product.

68. The meat substitute product according to anyone of clauses 1 to 43 or anyone of clauses 61 to 67 comprising:
a fat composition in an amount of from 2 to 25% on the total weight of the meat substitute product, and wax present in an amount of from 2 to 8%, by weight of the fat composition, and
at least one texturized protein ingredient in an amount of from 12 to 22%, expressed as dry weight on total weight of the meat substitute product, and
a protein ingredient an amount of from 2.0 to 8.0 wt %, on the total weight of meat substitute product, and
one or more hydrocolloids in an amount of each hydrocolloid, in an amount of from 0.2 to 2.5 wt %, on the total weight of the meat substitute product, and
wherein the fat composition is present as a fat component and optionally additional liquid oil and the fat component is further structured with the wax into a fat chip or fat bead; and the fat chip or fat bead is consisting of solid fat/liquid oil/wax; and the solid fat is coconut oil and the liquid oil is selected from the group consisting of rapeseed oil, canola oil, high oleic rapeseed oil, high oleic canola oil, soybean oil, cottonseed oil and a combination of two or more thereof; and the wax is selected from rice bran wax, sunflower wax, candelilla and carnauba wax; and the solid fat/liquid oil/wax ratios in the fat chip is from 32/60/8 to 75/20/5, and
wherein the meat substitute product is a ground meat substitute product, preferably a ground vegetarian protein product.

69. The meat substitute product according to anyone of clauses 1 to 43 or anyone of clauses 61 to 69 comprising:
a fat composition in an amount of from 2 to 25% on the total weight of the meat substitute product, and wax present in an amount of from 3 to 5% by weight of the fat composition, and
at least one texturized protein ingredient in an amount of from 15 to 20%, expressed as dry weight on total weight of the meat substitute product, and
a protein ingredient an amount of from 3.0 to 5.0 wt % on the total weight of meat substitute product, and
one or more hydrocolloids in an amount of each hydrocolloid, in an amount of from 0.3 to 2.0 wt % on the total weight of the meat substitute product, and
wherein the fat composition is present as a fat component and optionally additional liquid oil and the fat component is further structured with the wax into a fat chip or fat bead; and the fat chip or fat bead is consisting of solid fat/liquid oil/wax; and the solid fat is coconut oil and the liquid oil is selected from the group consisting of rapeseed oil, canola oil, high oleic rapeseed oil, high oleic canola oil, soybean oil, cottonseed oil and a combination of two or more thereof; and the wax is selected from rice bran wax, sunflower wax, candelilla and carnauba wax; and the solid fat/liquid oil/wax ratios in the fat chip is from 32/60/8 to 75/20/5, and
wherein the meat substitute product is a ground meat substitute product, preferably a ground vegetarian protein product.

70. The meat substitute product according to anyone of clauses 1 to 43 or anyone of clauses 61 to 70 comprising:
a fat composition in an amount of from 4 to 15% on the total weight of the meat substitute product, and wax present in an amount of from 1 to 10%, by weight of the fat composition, and
at least one texturized protein ingredient in an amount of from 10 to 25%, expressed as dry weight on total weight of the meat substitute product, and
a protein ingredient an amount of from 1.0 to 10.0 wt %, on the total weight of meat substitute product, and
one or more hydrocolloids in an amount of each hydrocolloid, in an amount of from 0.1 to 3.0 wt %, on the total weight of the meat substitute product, and
wherein the fat composition is present as a fat component and optionally additional liquid oil and the fat component is further structured with the wax into a fat chip or fat bead; and the fat chip or fat bead is consisting of solid fat/liquid oil/wax; and the solid fat is coconut oil and the liquid oil is selected from the group consisting of rapeseed oil, canola oil, high oleic rapeseed oil, high oleic canola oil, soybean oil, cottonseed oil and a combination of two or more thereof; and the wax is selected from rice bran wax, sunflower wax, candelilla and carnauba wax; and the solid fat/liquid oil/wax ratios in the fat chip is from 32/60/5 to 75/20/5, and
wherein the meat substitute product is a ground meat substitute product, preferably a ground vegetarian protein product.

71. The meat substitute product according to anyone of clauses 1 to 43 or anyone of clauses 61 to 70 comprising:
a fat composition in an amount of from 4 to 15% on the total weight of the meat substitute product, and wax present in an amount of from 2 to 8%, by weight of the fat composition, and
at least one texturized protein ingredient in an amount of from 12 to 22%, expressed as dry weight on total weight of the meat substitute product, and
a protein ingredient an amount of from 2.0 to 8.0 wt %, on the total weight of meat substitute product, and
one or more hydrocolloids in an amount of each hydrocolloid, in an amount of from 0.2 to 2.5 wt %, on the total weight of the meat substitute product, and
wherein the fat composition is present as a fat component and optionally additional liquid oil and the fat component is further structured with the wax into a fat chip or fat bead; and the fat chip or fat bead is consisting of solid fat/liquid oil/wax; and the solid fat is coconut oil and the liquid oil is selected from the group consisting of rapeseed oil, canola oil, high oleic rapeseed oil, high oleic canola oil, soybean oil, cottonseed oil and a combination of two or more thereof; and the wax is selected from rice bran wax, sunflower wax, candelilla and carnauba wax; and the solid fat/liquid oil/wax ratios in the fat chip is from 32/60/8 to 75/20/5, and
wherein the meat substitute product is a ground meat substitute product, preferably a ground vegetarian protein product.

72. The meat substitute product according to anyone of clauses 1 to 43 or anyone of clauses 61 to 71 comprising:
a fat composition in an amount of from 4 to 15% on the total weight of the meat substitute product, and wax present in an amount of from 3 to 5% by weight of the fat composition, and
at least one texturized protein ingredient in an amount of from 15 to 20%, expressed as dry weight on total weight of the meat substitute product, and
a protein ingredient an amount of from 3.0 to 5.0 wt % on the total weight of meat substitute product, and
one or more hydrocolloids in an amount of each hydrocolloid, in an amount of from 0.3 to 2.0 wt % on the total weight of the meat substitute product, and
wherein the fat composition is present as a fat component and optionally additional liquid oil and the fat component is further structured with the wax into a fat chip or fat bead; and the fat chip or fat bead is consisting of solid fat/liquid oil/wax; and the solid fat is coconut oil and the liquid oil is selected from the group consisting of rapeseed oil, canola oil, high oleic rapeseed oil, high oleic canola oil, soybean oil, cottonseed oil and a combination of two or more thereof; and the wax is selected from rice bran wax, sunflower wax, candelilla and carnauba wax; and the solid fat/liquid oil/wax ratios in the fat chip is from 32/60/8 to 75/20/5, and
wherein the meat substitute product is a ground meat substitute product, preferably a ground vegetarian protein product.

73. The meat substitute product according to anyone of clauses 1 to 43 or anyone of clauses 61 to 72 comprising:
a fat composition in an amount of from 5 to 12% on the total weight of the meat substitute product, and wax present in an amount of from 1 to 10%, by weight of the fat composition, and
at least one texturized protein ingredient in an amount of from 10 to 25%, expressed as dry weight on total weight of the meat substitute product, and
a protein ingredient an amount of from 1.0 to 10.0 wt %, on the total weight of meat substitute product, and
one or more hydrocolloids in an amount of each hydrocolloid, in an amount of from 0.1 to 3.0 wt %, on the total weight of the meat substitute product, and
wherein the fat composition is present as a fat component and optionally additional liquid oil and the fat component is further structured with the wax into a fat chip or fat bead; and the fat chip or fat bead is consisting of solid fat/liquid oil/wax; and the solid fat is coconut oil and the liquid oil is selected from the group consisting of rapeseed oil, canola oil, high oleic rapeseed oil, high oleic canola oil, soybean oil, cottonseed oil and a combination of two or more thereof; and the wax is selected from rice bran wax, sunflower wax, candelilla and carnauba wax; and the solid fat/liquid oil/wax ratios in the fat chip is from 32/60/8 to 75/20/5, and
wherein the meat substitute product is a ground meat substitute product, preferably a ground vegetarian protein product.

74. The meat substitute product according to anyone of clauses 1 to 43 or anyone of clauses 61 to 73 comprising:
a fat composition in an amount of from 5 to 12% on the total weight of the meat substitute product, and wax present in an amount of from 2 to 8%, by weight of the fat composition, and
at least one texturized protein ingredient in an amount of from 12 to 22%, expressed as dry weight on total weight of the meat substitute product, and
a protein ingredient an amount of from 2.0 to 8.0 wt %, on the total weight of meat substitute product, and
one or more hydrocolloids in an amount of each hydrocolloid, in an amount of from 0.2 to 2.5 wt %, on the total weight of the meat substitute product, and
wherein the fat composition is present as a fat component and optionally additional liquid oil and the fat component is further structured with the wax into a fat chip or fat bead; and the fat chip or fat bead is consisting of solid fat/liquid oil/wax; and the solid fat is coconut oil and the liquid oil is selected from the group consisting of rapeseed oil, canola oil, high oleic rapeseed oil, high oleic canola oil, soybean oil, cottonseed oil and a combination of two or more thereof; and the wax is selected from rice bran wax, sunflower wax, candelilla and carnauba wax; and the solid fat/liquid oil/wax ratios in the fat chip is from 32/60/8 to 75/20/5, and
wherein the meat substitute product is a ground meat substitute product, preferably a ground vegetarian protein product.

75. The meat substitute product according to anyone of clauses 1 to 43 or anyone of clauses 61 to 74 comprising:
a fat composition in an amount of from 5 to 12% on the total weight of the meat substitute product, and wax present in an amount of from 3 to 5% by weight of the fat composition, and
at least one texturized protein ingredient in an amount of from 15 to 20%, expressed as dry weight on total weight of the meat substitute product, and
a protein ingredient an amount of from 3.0 to 5.0 wt % on the total weight of meat substitute product, and
one or more hydrocolloids in an amount of each hydrocolloid, in an amount of from 0.3 to 2.0 wt % on the total weight of the meat substitute product, and
wherein the fat composition is present as a fat component and optionally additional liquid oil and the fat component is further structured with the wax into a fat chip or fat bead; and the fat chip or fat bead is consisting of solid fat/liquid oil/wax; and the solid fat is coconut oil and the liquid oil is selected from the group consisting of rapeseed oil, canola oil, high oleic rapeseed oil, high oleic canola oil, soybean oil, cottonseed oil and a combination of two or more thereof; and the wax is selected from rice bran wax, sunflower wax, candelilla and carnauba wax; and the solid fat/liquid oil/wax ratios in the fat chip is from 32/60/8 to 75/20/5, and
wherein the meat substitute product is a ground meat substitute product, preferably a ground vegetarian protein product.

76. A method of producing a meat substitute product according to anyone of clauses 1 to 43 or anyone of clauses 61 to 75 comprising the following steps: mixing meat substitute product ingredients, adding a fat composition consisting of solid fat, liquid oil, forming the meat substitute product.

77. A method of producing a meat substitute product according to anyone of clauses 1 to 43 or anyone of clauses 61 to 75 comprising the following steps: mixing meat substitute product ingredients, optionally including the additional liquid oil, adding a fat bead or fat chip according to anyone of clauses 44 to 58 and, forming the meat substitute product.

78. A method according to anyone of clause 76 to 77 for producing a meat substitute product according to anyone of clauses 1 to 43 or anyone of clauses 61 to 75 comprising the following steps: mixing meat substitute product ingredients, optionally including the additional liquid oil; adding the fat chip or fat bead according to anyone of clauses 44 to 58 and which is consisting of the fat component and wax as a structuring agent wherein the fat component is a combination of solid fat and liquid oil and the wax is present in an amount of 1 to 10% by weight of the fat chip or fat bead.

79. The method according to clause 78 wherein the fat chip or fat bead is comprising solid fat/liquid oil/wax in a ratio of from 32/60/5 to 75/20/5.

80. The method according to anyone of clause 76 to 79 for producing a meat substitute product according to anyone of clauses 1 to 43 or anyone of clauses 61 to 75 comprising the following steps: mixing meat substitute product ingredients, including the additional liquid oil; adding the fat chip or fat bead according to anyone of clause 44 to 58, and which is consisting of the fat component and wax as a structuring agent wherein the fat component is a combination of solid fat and liquid oil and the wax is present in an amount of 1 to 10% by weight of the fat chip or fat bead.

81. The method according to anyone of clauses 76 to 80 wherein the liquid oil is selected from the group consisting of rapeseed oil, canola oil, high oleic rapeseed oil, high oleic canola oil, soybean oil, cottonseed oil and a combination of two or more thereof, and wherein the optional additional oil is the same of different from the liquid oil of the fat chip or fat bead according to anyone of clauses 44 to 58

82. Use of the fat chip or fat bead according to anyone of clauses 44 to 58 or prepared according to the process of clause 59 or 60, and the fat bead or fat chip is comprising a combination of solid fat and liquid oil and the wax is present in an amount of 1 to 10% by weight of the fat chip or fat bead, for improving the appearance, texture and/or organoleptic properties of a ground meat substitute product.

83. The use according to clause 82 wherein the fat chip or fat bead is comprising a combination of solid fat and liquid oil and the wax is present in an amount of 1 to 8% by weight of the fat chip or fat bead.

84. The use according to clause 82 or 83 wherein the fat chip or fat bead is comprising solid fat/liquid oil/wax in a ratio of from 32/60/8 to 75/20/5.

85. The use according to anyone of clauses 82 to 84 wherein the solid fat is coconut oil and the liquid oil is selected from the group consisting of rapeseed oil, canola oil, high oleic rapeseed oil, high oleic canola oil, soybean oil, cottonseed oil and a combination of two or more thereof, the wax is selected from rice bran wax, sunflower wax, candelilla and carnauba wax and the solid fat/liquid oil/wax ratios is from 32/60/8 to 75/20/5.

86. The use according to anyone of clauses 82 to 85 wherein the fat chip or fat bead is comprising a combination of solid fat and liquid oil and the wax is present in an amount of 1 to 8% by weight of the fat chip or fat bead, for reducing the content of saturated fatty acids with at least 20%, at least 30%, at least 40%, at least 50%. in a meat substitute product.

87. Use of a fat chip or fat bead wherein the fat chip or fat bead is comprising a combination of solid fat and liquid oil and the wax is present in an amount of 1 to 10% by weight of the fat chip or fat bead, for reducing the content of saturated fatty acids with at least 20%, at least 30%, at least 40%, at least 50%.

The invention is further illustrated with the following examples.

### EXAMPLES

### 1. Flakes of Fat and Wax (Fat Chips or Fat Beads)

The solid fat, the liquid oil and the wax were combined in the following ratios as is shown in table 1 and formed into fat chips or beads.

TABLE 1

| Blend | | |
|---|---|---|
| Code | Description | SAFA Reduction |
| 1 | coconut oil control | |
| 2 | 65/30/5 CNO/HOCAN/RBW | 33% |
| 3 | 60/35/5 | 30% |
| | CNO/COTTON/SFW | |
| 4 | 75/20/5 CNO/SBO/SFW | 22% |
| 5 | 65/30/5 CNO/SBO/SFW | 30% |
| 6 | 65/30/5 CNO/SBO/RBW | 30% |
| 7 | 40/53/7 CNO/HOCAN/RBW | 61% |
| 8 | 32.5/60/7.5 | 54% |
| | CNO/HOCAN/RBW | |
| 9 | 40/54/6 CNO/HOCAN/RBW | 53% |
| 10 | 40/55/5 CNO/SBO/RBW | 50% |
| 11 | 45/50/5 CNO/HOCAN/RBW | 50% |

CNO = Coconut oil
COTTON = Cottonseed oil
HOCAN = High oleic canola oil
RBW = Rice bran wax
SBO = Soybean oil
SFW = Sunflower wax
Fatty acid profiles (by GC-FID) (Area %)

TABLE 2

| Fatty Acid | | | | Coconut |
|---|---|---|---|---|
| Profile by GC- | Blend | Blend | | Oil |
| FID (Area %) | 8 | 9 | Blend 7 | 100%) |
| C8:0 | 2.93 | 3.01 | 2.46 | 5.05 |
| (caprylic acid) | | | | |
| [area %] | | | | |
| C10:0 | 2.39 | 2.45 | 2 | 4.72 |
| (capric acid) | | | | |
| [area %] | | | | |
| C12:0 | 19.42 | 19.87 | 16.14 | 44.01 |
| (lauric acid) | | | | |
| [area %] | | | | |
| C14:0 | 7.75 | 7.92 | 6.41 | 19.77 |
| (myristic acid) | | | | |
| [area %] | | | | |
| C15:0 | 0.02 | 0.02 | 0.02 | 0.01 |
| (pentadecanoic | | | | |
| acid) [area %] | | | | |
| C16:0 | 6.22 | 6.26 | 5.81 | 11.15 |
| (palmitic acid) | | | | |
| [area %] | | | | |
| C16:1 | 0.16 | 0.17 | 0.18 | 0.02 |
| (palmitoleic | | | | |
| acid) [area %] | | | | |
| C17:0 | 0.03 | 0.03 | 0.03 | 0.01 |
| (margaric | | | | |
| acid) [area %] | | | | |
| C17:1 | ND | ND | ND | ND |
| (margaroleic | | | | |
| acid) [area %] | | | | |
| C18:0 | 2.28 | 2.27 | 2.17 | 3.96 |
| (stearic acid) | | | | |
| [area %] | | | | |
| C18:1 | 44 | 43.37 | 48.4 | 8.82 |
| cis (oleic acid) | | | | |
| [area %] | | | | |
| C18:1 | 0.03 | 0.03 | 0.03 | 0.03 |
| trans (elaidic | | | | |
| acid) [area %] | | | | |
| C18:1 | 44.03 | 43.4 | 48.43 | 8.85 |
| total (oleic | | | | |
| acid) [area %] | | | | |
| C18:2 | 11.38 | 11.23 | 12.54 | 2.16 |
| cis (linoleic | | | | |
| acid) [area %] | | | | |
| C18:2 | 0.09 | 0.09 | 0.11 | 0.03 |
| trans | | | | |
| (linolelaidic | | | | |
| acid) [area %] | | | | |
| C18:2 | 11.47 | 11.32 | 12.65 | 2.19 |
| total (linoleic | | | | |
| acid) [area %] | | | | |
| C18:3 | 1.81 | 1.78 | 2.03 | 0.01 |
| cis (linolenic | | | | |
| acid) [area %] | | | | |
| C18:3 | 0.14 | 0.14 | 0.17 | ND |
| trans | | | | |
| (linolenelaidic | | | | |
| acid) [area %] | | | | |
| C18:3 | 1.95 | 1.92 | 2.2 | 0.01 |
| total (linolenic | | | | |
| acid) [area %] | | | | |
| C20:0 | 0.35 | 0.35 | 0.39 | 0.12 |
| (arachidic | | | | |
| acid) [area %] | | | | |
| C20:1 | 0.73 | 0.73 | 0.83 | 0.06 |
| (eicosenoic | | | | |
| acid) [area %] | | | | |
| C22:0 | 0.2 | 0.19 | 0.22 | 0.02 |
| (behenic acid) | | | | |
| [area %] | | | | |
| C22:1 | ND | ND | ND | ND |
| (erucic acid) | | | | |
| [area %] | | | | |
| C24:0 | 0.01 | 0.02 | 0.02 | 0.01 |
| (lignoceric | | | | |
| acid) [area %] | | | | |
| MUFA | 44.92 | 44.3 | 49.44 | 8.93 |
| [area %] | | | | |
| PUFA | 13.42 | 13.24 | 14.85 | 2.20 |
| [area %] | | | | |
| SAFA | 41.6 | 42.39 | 35.67 | 88.83 |
| [area %] | | | | |
| Trans | 0.26 | 0.26 | 0.31 | 0.06 |
| FA [area %] | | | | |
| Iodine | 63.55 | 62.68 | 70.13 | 11.50 |
| Value | | | | |
| Mettler | 67.1 | 68 | 68.2 | 26.20 |
| Dropping | | | | |
| Point (MDP) | | | | |

| Fatty Acid | | | Coconut |
|---|---|---|---|
| Profile by GC- | Blend | Blend | Oil |
| FID (Area %) | 10 | 11 | 100%) |
| C6:0 (caproic | 0.25 | 0.27 | |
| acid) | | | |
| C8:0 | 3.00 | 3.33 | 5.05 |
| (caprylic acid) | | | |
| [area %] | | | |
| C10:0 | 2.38 | 2.65 | 4.72 |
| (capric acid) | | | |
| [area %] | | | |
| C12:0 | 19.08 | 21.52 | 44.01 |
| (lauric acid) | | | |
| [area %] | | | |
| C14:0 | 7.47 | 8.56 | 19.77 |
| (myristic acid) | | | |
| [area %] | | | |
| C15:0 | 0.01 | 0.02 | 0.01 |
| (pentadecanoic | | | |
| acid) [area %] | | | |
| C16:0 | 9.91 | 6.34 | 11.15 |
| (palmitic acid) | | | |
| [area %] | | | |
| C16:1 | 0.07 | 0.15 | 0.02 |
| (palmitoleic | | | |
| acid) [area %] | | | |
| C17:0 | 0.06 | 0.03 | 0.01 |
| (margaric | | | |
| acid) [area %] | | | |
| C17:1 | 0.03 | 0.03 | ND |
| (margaroleic | | | |
| acid) [area %] | | | |
| C18:0 | 3.62 | 2.32 | 3.96 |
| (stearic acid) | | | |
| [area %] | | | |
| C18:1 | 17.48 | 41.29 | 8.82 |
| cis (oleic acid) | | | |
| [area %] | | | |
| C18:1 | 0.03 | 0.06 | 0.03 |
| trans (elaidic | | | |
| acid) [area %] | | | |
| C18:1 | 17.51 | 41.35 | 8.85 |
| total (oleic | | | |
| acid) [area %] | | | |
| C18:2 | 31.47 | 10.50 | 2.16 |
| cis (linoleic | | | |
| acid) [area %] | | | |
| C18:2 | 0.23 | 0.08 | 0.03 |
| trans | | | |
| (linolelaidic | | | |
| acid) [area %] | | | |
| C18:2 | 31.70 | 10.58 | 2.19 |
| total (linoleic | | | |
| acid) [area %] | | | |
| C18:3 | 3.68 | 1.45 | 0.01 |
| cis (linolenic | | | |
| acid) [area %] | | | |
| C18:3 | 0.46 | 0.11 | ND |
| trans | | | |
| (linolenelaidic | | | |
| acid) [area %] | | | |
| C18:3 | 4.14 | 1.56 | 0.01 |
| total (linolenic | | | |
| acid) [area %] | | | |
| C20:0 | 0.24 | 0.33 | 0.12 |
| (arachidic | | | |
| acid) [area %] | | | |
| C20:1 | 0.08 | 0.56 | 0.06 |
| (eicosenoic | | | |
| acid) [area %] | | | |
| C22:0 | 0.22 | 0.17 | 0.02 |
| (behenic acid) | | | |
| area %] | | | |
| C22:1 | 0.01 | 0.01 | ND |
| (erucic acid) | | | |
| [area %] | | | |
| C24:0 | 0.12 | 0.13 | 0.01 |
| (lignoceric | | | |
| acid) [area %] | | | |
| MUFA | 17.70 | 42.10 | 8.93 |
| [area %] | | | |
| PUFA | 35.84 | 12.14 | 2.20 |
| [area %] | | | |
| SAFA | 46.36 | 45.67 | 88.83 |
| [area %] | | | |
| Trans | 0.72 | 0.25 | 0.06 |
| FA [area %] | | | |
| Iodine | 80.95 | 58.58 | 11.50 |
| Value | | | |
| Mettler | 65.70 | 65.30 | 26.20 |
| Dropping | | | |
| Point (MDP) | | | |

SFC data by NMR (expressed in %):

TABLE 3

| | Blend | Blend | Blend | Blend | Blend |
|---|---|---|---|---|---|
| ° C. | 8 | 9 | 7 | 10 | 11 |
| 10 | 22.6 | 23.8 | 17.4 | 22.98 | 27.21 |
| 20 | 3.9 | 5.1 | 4.5 | 3.23 | 4.43 |
| 21.1 | 3.6 | 4.2 | 4.5 | 3.01 | 3.52 |
| 25 | 3.7 | 4.1 | 4.3 | 3.23 | 3.39 |
| 26.7 | 3.6 | 4.2 | 4.7 | 3.21 | 3.14 |
| 30 | 3.8 | 4.4 | 4.5 | 3.26 | 3.14 |
| 33.3 | 3.9 | 4.5 | 4.6 | 3.25 | 3.50 |
| 35 | 3.8 | 4.5 | 4.9 | 3.47 | 3.40 |
| 37.8 | 3.8 | 4.3 | 4.7 | 3.66 | 3.47 |
| 40 | 3.8 | 4.6 | 5.0 | 3.76 | 3.41 |

### 2. Recipe of the Meat Substitute Product

The recipe of the meat substitute products is shown in table 2.

TABLE 4
Recipe of the meat substitute product

| Ingredient Description | Percentages |
|---|---|
| Water | 64.8% |
| Methylcellulose | 1.2% |
| Canola oil | 4% |
| Flavors and/or Salt | 4.3% |
| Colors | 1% |
| Texturized Pea Protein | 14.5% |
| Pea Protein | 3% |
| Carrageenan | 0.2% |
| Flakes of fat and wax* (Fat | 7% |
| chips or fat beads) | |

Flakes of fat and wax *= according to the description in table 1 in the form of fat chips or beads.
Fat composition is fat component + canola oil.
The fat component is structured with wax into fat chips or fat beads according to the description in table 1

### 3. Preparation of the Meat Substitute Product

### Mixing

1. Methylcellulose emulsion: Added oil and fat −soluble flavors to food processor with methylcellulose. Blended until fully dispersed, then added all remaining water (chilled to <40F; <4° C.) and blended until frothy white gel forms (approx. 1 minute). Refrigerate until ready to use.
2. Textured Protein Hydration: Mix salt, water-soluble flavors and colors into sub-portion of the water sufficient to hydrate textured protein by using a paddle mixer. Add textured protein and blend for 4 minutes until fully hydrated.
3. Add pea protein and carrageenan to the hydrated textured protein and blend until no dry clumps remain.
4. Add methylcellulose emulsion to hydrated protein blend and blend until incorporated. (approx. 1 minute), scrape 30 sec to 1 minute. (Optional: if necessary, cool prior to adding fat chips, depending on blend temperature).)
5. Add “fat chip or bead form and blend until just incorporated, about 1 minute

### Forming

6. Chilled mass in refrigerator to help with forming
7. Scaled patties to desired weight/size and form. Target=113 g+:−1 g
8. Quick freeze in blast freezer.

### Reheating for Evaluation

9. Thawing patties in refrigerator for 24 hours prior to evaluation.
10. Cooking patties on flat top or in pan over medium heat, flipping at about 4 minutes, until they reach an internal temperature >165F (>74° C.). Total cook time anticipated ˜9 min.

### Results

The cooking performance and fat release was similar for all samples.

Analysis of the interior of the cooked patties: Samples including Blends 1-3 had a very similar appearance, fat particles melted down completely. Blend 4 had a slight waxy sheen on the top of the patty. Samples including Blends 5 and 6 had visible un-melted fat pieces inside the patty after cooking.

Sample including Blend 2 was the most preferred with a good level of juiciness and uniform texture. It was juicier than the control.

Sample including Blend 3 and 4 were similar with mild mouthcoating and medium juiciness.

Samples including Blend 5 and 6 had visual fatty chunks left over and greater mouthcoating than some of the earlier samples, tallow-like mouthcoating. Both more moist/juicy than the control.

Sample including Blend 5 had the most mouthcoating.

1. A meat substitute product comprising a fat composition, a wax, and at least one texturized protein ingredient.

2. The meat substitute product according to claim 1 wherein the wax is selected from rice bran wax, sunflower wax, candelilla and carnauba wax.

3. The meat substitute product according to claim 1, wherein the meat substitute product comprises the fat composition in an amount of 2 to 25% by weight of said meat substitute product.

4. The meat substitute product according to claim 1, wherein the fat composition present in the meat substitute product is a combination of a fat component and optionally additional liquid oil and the fat component is consisting of solid fat and liquid oil.

5. The meat substitute product according to claim 4, wherein the solid fat is selected from the group consisting of palm oil, palm kernel oil, coconut oil, cacao butter, shea butter and a combination of two or more thereof.

6. The meat substitute product according to claim 4, wherein the solid fat is coconut oil.

7. The meat substitute product according to claim 4, wherein the liquid oil is selected from the group consisting of: rapeseed oil, high oleic rapeseed oil, sunflower oil, high oleic sunflower oil, canola oil, high oleic canola oil, high oleic soybean oil, soybean oil, flaxseed oil, grapeseed oil, olive oil, peanut oil, corn oil, groundnut oil, cottonseed oil and a combination of two or more thereof.

8. The meat substitute product according to claim 4, wherein the liquid oil is selected from the group consisting of: canola oil, rapeseed oil, high oleic rapeseed oil, high oleic canola oil, soybean oil, cottonseed oil and a combination of two or more thereof.

9. The meat substitute product according to claim 4, wherein the fat composition is present in an amount of 2-25% by weight of said meat substitute product, and wherein the fat composition is consisting of an additional liquid oil and a fat component wherein the fat component is consisting of coconut oil and a liquid oil selected from the group consisting of rapeseed oil, canola oil, high oleic rapeseed oil, high oleic canola oil, soybean oil, and cottonseed oil and a combination of two or more thereof, and wherein the liquid oil and the additional liquid oil is the same or different.

10. The meat substitute product according to claim 1, wherein the meat substitute product comprises the wax in an amount of 1 to 10% by weight of the fat component.'

11. The meat substitute product according to claim 1, wherein the texturized protein ingredient is from a vegetable source selected from the group consisting of pea protein, chickpea beans protein, soy protein, cotton seed protein, sunflower seed protein, lupin protein, oat protein, lentil protein, sesame seed protein, canola protein, broad been protein, horse bean protein, alfalfa protein, clover protein, rice protein, tapioca protein, potato protein, carob protein and corn protein and a combination of two or more thereof.

12. The meat substitute product according to claim 1 comprising the fat composition in an amount of 2-25% by weight of the meat substitute product, wax in an amount of 0.02-0.7% by weight of the meat substitute product, texturized protein ingredient in an amount of 10-20% by weight of the meat substitute product.

13. A fat chip or fat bead comprising a fat component and wax as a structuring agent wherein fat component is a combination of solid fat and liquid oil and the wax is present in an amount of 1 to 10% by weight of the fat chip or fat bead.

14. A method of producing a meat substitute product according to claim 1 and the method is comprising the following steps: mixing meat substitute product ingredients, adding wax, a fat composition consisting of a fat component and optionally additional liquid oil wherein the fat component is consisting of a solid fat and liquid oil, forming the meat substitute product.

15. (canceled)
